(19) United States
(12) Patent Application Publication
(10) Pub. No.: US 2019/0259096 A1
(43) Pub. Date: Aug. 22, 2019

(54) SOCIAL FINANCE PLATFORM SYSTEM AND METHOD

(71) Applicant: Jelli, LLC, Newbury Park, CA (US)

(72) Inventors: David R. Smith, Newbury Park, CA (US); Ben Harper, Camarillo, CA (US); Tom Curitore, Los Angeles, CA (US); Miranda Perry, Los Angeles, CA (US)

(21) Appl. No.: 16/287,464

(22) Filed: Feb. 27, 2019

Related U.S. Application Data
(63) Continuation of application No. 15/243,262, filed on Aug. 22, 2016, now abandoned.
(60) Provisional application No. 62/209,782, filed on Aug. 25, 2015.

(51) Int. Cl. G06Q 40/02; G06Q 50/00

(52) U.S. Cl. CPC G06Q 40/02; G06Q 50/01

(57) ABSTRACT

In one example, a method includes receiving a request to create a user profile unique to a particular user, receiving and verifying information provided in the request, creating the user profile, and transmitting a confirmation that the user profile has been created. The method can further include receiving, from a user to whom the user profile corresponds, a virtual container definition, creating a virtual container based on the virtual container definition, storing the virtual container in a virtual container database, and confirming to the user that the virtual container has been created.

### RELATED APPLICATIONS

This application is a continuation of, and hereby claims priority to, U.S. patent application Ser. No. 15/243,262, entitled SOCIAL FINANCE PLATFORM SYSTEM AND METHOD, filed Aug. 22, 2016 (the “'262 application”). The '262 application, in turn, claims priority to, and the benefit of, U.S. Provisional Patent Application, Ser. 62/209,782, entitled SOCIAL FINANCE PLATFORM SYSTEM AND METHOD, filed Aug. 25, 2015. All of the aforementioned applications are incorporated herein in their respective entireties by this reference.

### FIELD OF THE INVENTION

The present disclosure is generally concerned with methods and systems that enable integration and interoperability of a variety of different socially based platforms.

### BACKGROUND

Various personal finance systems have been developed that take advantage of technical advances in areas such as networked computing and peer-to-peer functions. In fact, at least some of such personal finance systems would not be viable and could not exist absent such technical advances, as there would be no technical platforms and associated functionality by way of which those personal finance systems could be implemented and operated.

Although improvements have been made in the area of personal finance methods and systems, challenges nonetheless remain. For example, the personal finance industry is highly fragmented. This fragmentation reflects the emphasis that has been placed on specific individual areas of interest in the personal finance space. Thus, for example, separate and discrete systems exist for areas such as crowdfunding and gift cards. The differing emphases, in turn, reflect the need for different personal finance functions, and the complexity of implementing and operating each different personal finance function.

In light of the aforementioned, and other, problems, it would be useful to be able to integrate aspects of various different personal finance functions into a single, multi-functional, platform. As well, it would be useful to be able to implement peer-to-peer functionality in one or more aspects of a multi-functional social finance platform. Finally, it would be useful to provide a social finance platform and system that enables multiple users to connect with each other on a social plane, as well as on a financial plane.

### BRIEF DESCRIPTION OF THE DRAWINGS

The appended drawings contain figures of some example embodiments to further clarify various aspects of the present disclosure. It will be appreciated that these drawings depict only some embodiments of the disclosure and are not intended to limit its scope in any way. The disclosure will be described and explained with additional specificity and detail through the use of the accompanying drawings in which:

FIG. 1 discloses aspects of an example operating environment;

FIG. 2 discloses one particular example of an operating environment for some embodiments of the invention;

FIG. 3 discloses aspects of an example host system;

FIG. 4 is a flow diagram disclosing aspects of an example method for creating a virtual container;

FIG. 5a is a flow diagram disclosing aspects of an example method for using a virtual container;

FIG. 5b is a flow diagram disclosing aspects of an example method for contributing to a virtual container;

FIG. 6 is a flow diagram disclosing aspects of an example method including processes performed by a social finance platform of a service provider;

FIG. 7a discloses aspects of an example smartphone or other app that is operable to implement aspects of the disclosed technology; and

FIG. 7b discloses further information concerning the app and UI of FIG. 7a.

### DETAILED DESCRIPTION OF SOME EXAMPLE EMBODIMENTS

The present disclosure is generally concerned with the integration of a variety of personal finance functions into a single unified social finance platform. More particularly, at least some example embodiments of the invention relate to systems, hardware, computer-readable media, and methods and systems that enable integration and interoperability of a variety of different personal finance functions, examples of which include crowdfunding, social payments, gift cards, joint accounts, and budgeting.

In one example embodiment, a unified social finance platform is provided that enables users to access and use a variety of different personal finance, and/or other, functions. As well, this social finance platform enables users to engage on a social or personal level, as well as on a financial level. In general, the unified social finance platform provides for the definition and use of various virtual containers, which may also be referred to herein as ‘jars,’ into which funds can be placed, and from which funds can be withdrawn. As used herein, a ‘virtual container’ is an account that includes a representation of funds, rather than actual funds. The representation indicates the amount of actual funds which may be available to an authorized user of the virtual container and/or recipient. Also, as used herein, a ‘user’ refers broadly to any party who accesses and/or uses some aspect of the social finance platform, whether or not that user has an account or profile set up with the social finance platform.

Access to the virtual containers, such as for deposits and/or withdrawals, can be made dependent upon considerations such as the nature and purpose of a particular virtual container. By way of illustration, a gift card container can be configured so that anyone can place funds in the gift card container, but only the identified recipient can withdraw funds from the gift card container. This approach is consistent with the purposes of the gift card container, and also provides a measure of security with regard to the deposited funds. As one other example, a joint account container can be configured so that a defined group of individuals, for example, can both contribute funds to, and withdraw funds from, the joint account container.

Each of the virtual containers can be associated with a financial account. However, information concerning the associated financial account may be hidden from all but the owner of the virtual container. This arrangement can provide an additional degree of security for the funds in that virtual container.

In addition to providing various types of access to different virtual containers, the social finance platform can also provide for a stream, or social media feed, that provides updates and any other information to users concerning virtual containers and/or other users with which the user receiving the stream can, or does, interact. This stream can be provided to a user, for example, by way of a smartphone app on a user device. Examples of information that may be provided by the stream include a notification when someone has contributed to a virtual container belonging to the user, comments, video and other multimedia, photographs, invitations to contribute to another virtual container, and any other information relating to any aspect of the social finance platform. This also includes relevant advertisements that are related to the virtual container in some aspect.

In at least some implementations, the social finance platform is hosted on a server, or servers, accessible by a user through various client devices such as, for example, a mobile phone, tablet, laptop computer, desktop computer, or any other computing device, examples of which include wearable devices such as wristbands, rings, watches, necklaces, key fobs, as well as clothing or any other article(s) that include, or may, a computing device. The social finance platform can communicate with financial institutions such as banks and credit unions, as well as with transaction processors. Among other things then, the server enables the use and operation of the social finance platform by, for example, facilitating interactions and communications among a variety of disparate users, including users of the social finance platform whose ability to access and use virtual containers can vary from one user to another, and from one virtual container to another.

Advantageously then, embodiments of the invention provide for the implementation of a variety of different personal finance functions in a single user-accessible platform. In this way, a user can access and use these personal finance functions by way of a single portal and application, and the need for the user to employ multiple different personal finance portals is largely, if not completely, eliminated.

### A. Example Operating Environments

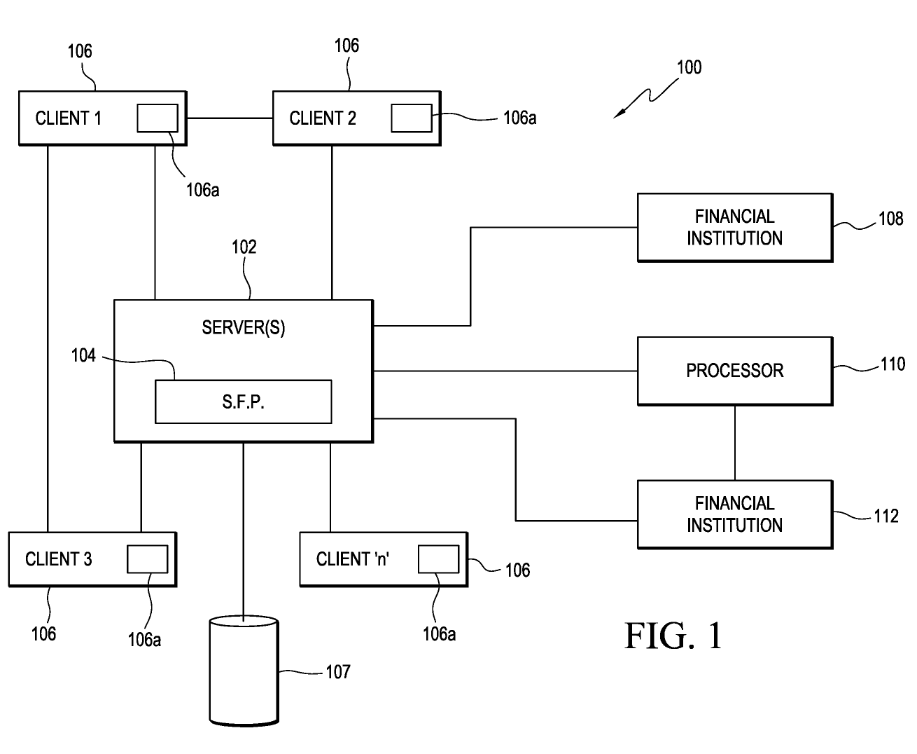

With reference now to FIG. 1, details are provided concerning an example operating environment for at least some embodiments of the invention. The operating environment 100 may be a network such as a local area network (LAN), a wide area network (WAN), the internet, or any other network configuration. Moreover, the operating environment 100, or any group of one or more of its elements, may comprise, form an element of, or constitute, a cloud computing environment. The operating environment 100 may include various devices including servers, clients and other computers and devices that are interconnected. Communications between and among elements of the operating environment 100 can take place in any manner. Thus, communications involving the operating environment 100 can take the form of wireless communications. Additionally, or alternatively, communications involving the operating environment 100 can take place over hardwire and/or optical connections.

In the embodiment disclosed in FIG. 1, the operating environment 100 includes one or more servers 102 which can form part of a cloud computing environment, although that is not required. The server 102 can act as a host for one or more instances of a social finance platform application 104. The operating environment 100 can also include 1 . . . n clients 106, each of which is able to communicate with the server 102, and one or more of which can include a social finance application client 106a, which may also be referred to herein by shorthand as a social finance platform ‘app’ regardless of the platform on which it is deployed, configured to interact with the social finance platform application 104. The clients 106 can also be configured to communicate with each other directly and/or by way of the server 102. The example operating environment 100 can also include one or more databases 107 which can retrievably store any information relating to the operation of the social finance platform application including, for example, information received by the server 102 from one or more of the clients 106, as well as information created by the server 102.

Thus, the operator of the server 102 and social finance platform application 104 acts as a service provider which provides services enabled and implemented by the server 102 and social finance platform application 104. The server 102 and social finance platform application 104 can be located on-premises at the service provider, although that is not required. Thus, in other embodiments, server 102 and social finance platform application 104 can be elements of a cloud computing system, for example.

As further indicated in FIG. 1, the social finance platform application 104 can communicate, by way of the server 102, with one or more financial institutions 108, such as banks, credit unions, and credit card companies for example. As well, the social finance platform application 104 can communicate with a processor 110, such as a financial transaction processor for example. The processor 110 can, in turn, communicate with a financial institution 112, as well as facilitate communications and transactions between the financial institution 112 and the social finance platform application 104. Thus, as indicated in the example of FIG. 1, the social finance platform application 104 can communicate in serial fashion with a processor 110 and the financial institution 112, and/or in parallel fashion with the processor 110 and the financial institution 108. As well, in some embodiments, the social finance platform application 104 can communicate, for example, with the financial institution 112 both directly and by way of the processor 110. In any event, it should be noted that the scope of the invention is not limited to any particular arrangement of the social finance platform application 104, financial institutions 108 and 112, and processor 110. Finally, the processor 110 can take the form for example, of an Automated Clearing House (ACH) network or entity, although that is not necessarily required.

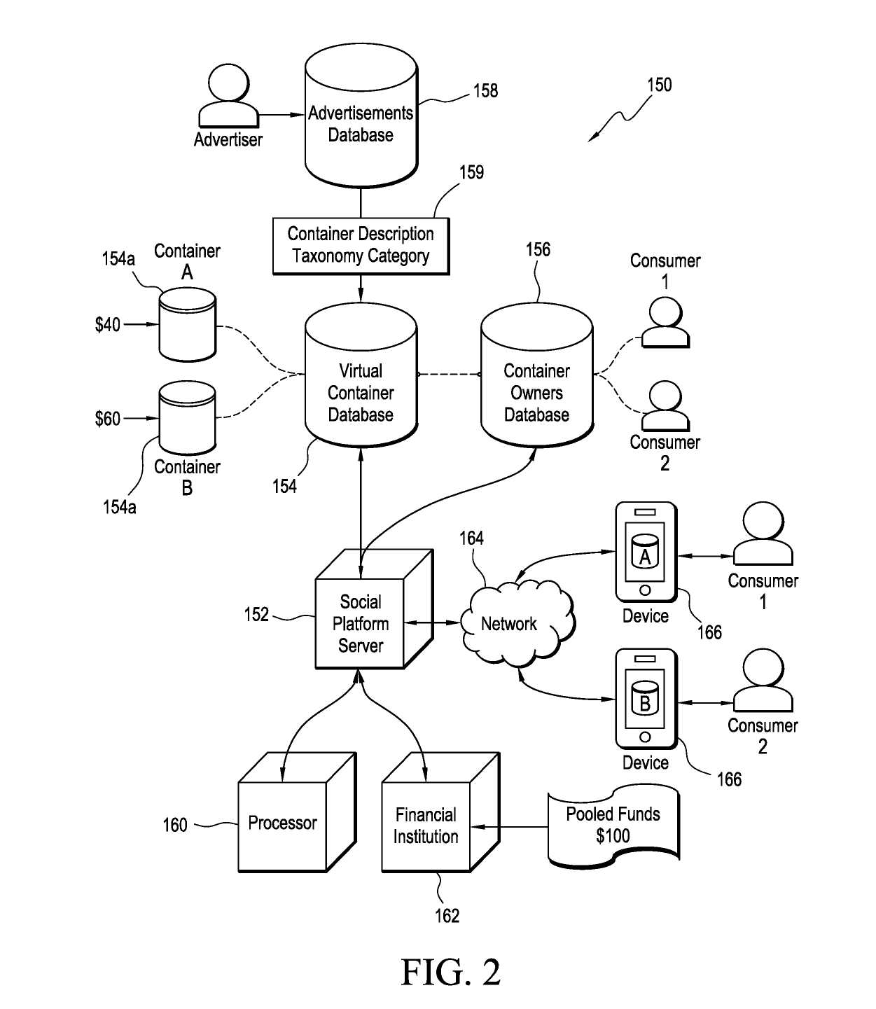

With reference now to FIG. 2, and continued reference to FIG. 1, details are provided concerning a more particular example operating environment, denoted generally at 150. Except as noted in the following discussion, the operating environment 150 can be similar, or identical, to the operating environment 100.

As indicated, the operating environment 150 can include a server 152 that hosts a social platform application and is configured to communicate with a virtual container database 154 and a container owners database 156. An advertisements database 158, accessible by one or more advertisers, can also be provided that is accessible, directly and/or indirectly, by the server 152, and enables the social finance platform to publish a variety of ads, which can include various forms of couponing for example, to users via the stream (social feed) and/or to users connected to the individual virtual container feed. One, some, or all, of the databases can be located on-premises with the server 152 or, alternatively, can be located off-premises, such as in a cloud storage environment for example.

As further indicated, the advertisements database 158 can operate in conjunction with container description and taxonomy category information 159. In general, the taxonomy category is the category that is generated by, or based upon, the parameters of the virtual container. If the parameters include a description of a computer, for example, then the taxonomy category could be “/electronics/computers.” Advertisers can buy ad space in these categories and ads are displayed whenever the category of a virtual container matches the ad category and/or other virtual container parameters.

By way of illustration, a virtual container may be identified as ‘Baby Shower for Marie’ and details in the virtual container description may include information such as ‘Hey everyone, let's pitch in and get Marie something great for her new baby. I know she would like one of those jogging strollers . . . . ’ This information provides details for advertisers and thus enables the provision of targeted ads. For example, and based on the container description and information noted in the aforementioned example, a jogging stroller manufacturer could pitch an ad for their jogging stroller. Also, since the social finance platform is aware of the $ amount in the virtual container ‘Baby Shower for Marie,’ the social finance platform possesses the information and intelligence to know whether to present an ad for an expensive stroller or a relatively less expensive stroller.

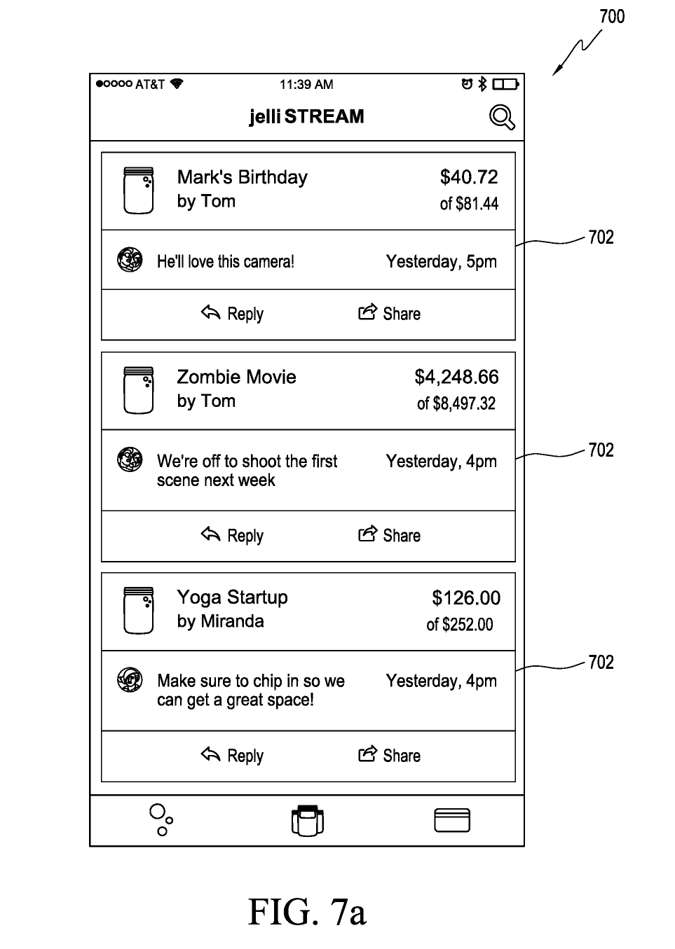

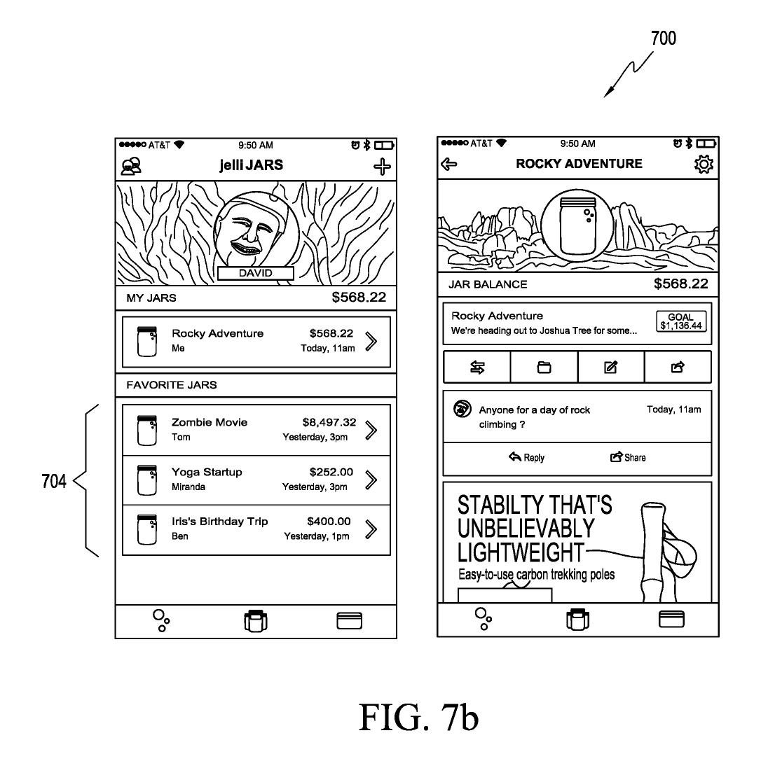

In more detail, the virtual container database 154 can store one or more virtual container profiles 154a that include the parameters that define the virtual container. The advertisements database 158 can include advertisements that may be added by the service provider to a stream (one example of which is disclosed in FIG. 7a) that is provided to a user, thus implementing an ad publishing functionality in the social finance platform. The advertisements can be added based upon information possessed by the service provider concerning, for example, a particular virtual container, a particular user, and/or any other information that would be useful in defining and transmitting targeted advertising for a user of the social finance platform. The container owners database 156 can include pertinent information concerning the owner of one or more virtual containers, such as information provided by the owner when the owner initially set up a profile or account with the service provider.

With continued reference to FIG. 2, and as noted in the discussion of FIG. 1, the social finance platform server 152 can communicate with a processor 160 and a financial institution 162. Finally, the social finance platform server 152 can be part of, or communicate with, a network 164 that enables communication between the social finance platform server 152 and one or more clients 166 such as smartphones, tablets, phablets, and any and all types of computers including desktop computers and laptop computers.

### B. Example Host Configuration

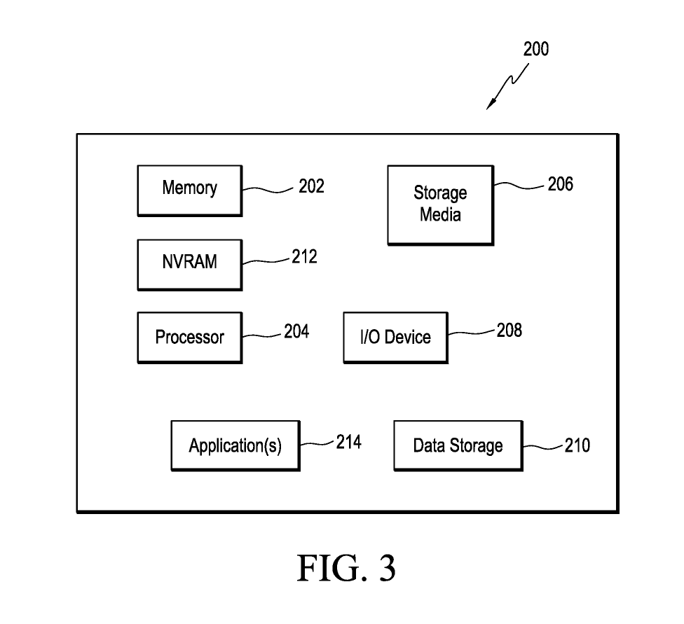

With reference briefly to FIG. 3, one or more of the server 102, server 152, client 106, client 166, financial institutions 108, 112 and 162, and processor 110 and 160, can consist of, comprise, or take the form of, one or more physical computing devices, one example of which is denoted at 200 in FIG. 3. In the example of FIG. 3, the computing device 200 includes a memory 202 which can include persistent and/or volatile memory, one or more hardware processors 204, non-transitory storage media 206, I/O device 208, data storage 210, and NVRAM 212. As well, one or more applications 214 are provided that comprise executable instructions. Such executable instructions can take the form, for example, of any one or more of a social finance platform application, and a social finance platform client. As well, the executable instructions can implement any of the methods disclosed herein. Additional, or alternative, applications can likewise be included in the applications 214.

### C. Aspects of Example Social Finance Platforms

As noted herein, the present disclosure is generally concerned with embodiments of a social finance platform and associated systems and methods. For example, the creator of a virtual container, discussed elsewhere herein, can give access to people to put money into the virtual container and he can grant access to others to pull money out. This functionality makes it usable as a crowd funding tool, or a joint account tool.

Another option as well is that the virtual container can be used analogously to an ‘envelope’ system of savings in which a group of envelopes is used to store money for various different purposes. For example, a consumer can set up various virtual containers for purposes such as a family trip, college fund, and a new car. Thus, embodiments of the invention provide a system and mechanism that enable users to segment their money into various purses. By way of contrast, most people just have a checking and savings account, and in the savings account, all the money is pooled and cannot be divided up into different purses.

In some example embodiments, four different virtual containers can be used, namely, crowd funding, social payments, gifting, and joint accounts. However, additional or alternative virtual container(s) can also be used. To illustrate, a user can have micro loans delivered to his virtual container for the purchase of a computer while he is in school, for example. The virtual container can be a depository for loan funds. An investment virtual container could also be provided.

As well, some embodiments provide that the entire virtual container can be gifted as well. For example, a father has a college fund virtual container and when his son heads off to college, the father gives his son the virtual container and transfers full control of the virtual container to his son. That also happens in the gift giving scenario, virtual container controls are transferred to a new owner, which is more than just granting access to someone to pull money from the virtual container, that person becomes the virtual container administrator.

In at least some embodiments, the social finance platform can be used in coordination with a wearable device such as a watch, ring, or wristband, that contain some form of NFC or other transmission tool and money storage technology for use at contactless terminals. For example, a wristband with a money storage device could be used in conjunction with a specific virtual container where the money is allocated for some purpose. Thus, a person might go to the beach and put $20 in a virtual container that is connected to a wearable device. The user can then access the funds in the virtual container via the wearable device, without any need to carry cash or credit cards. Thus, one or more virtual containers could be connected with and/or accessible by any number of wearable devices. By way of example, one virtual container could be connected to wristband for the beach while another container could be connected to a ring while the user is dining out. In some instances, multiple virtual containers can be associated with a single wearable device. Such wearable devices can employ Bluetooth, IEEE 802.11X, radio frequency (RF), or any other wireless communication technologies and protocols.

As another example, some embodiments of the invention can be used in coordination with a prepaid device as well as with a traditional bank debit card. In the case of a traditional bank debit card, a bank, such as Wells Fargo for example, will house the sum total of funds deposited into all the virtual containers owned by a particular user. Individual funds in the various virtual containers will be controlled by a processing system, which can be implemented at a processor (such as processor 110) and/or at a server (such as server 102 for example). A user can deposit funds into their various virtual containers using their bank debit card. Funds can be removed from the virtual container(s) and transferred to the overall bank account at Wells Fargo, for example, via MasterCard, Visa, Automated Clearing House (ACH), or other financial rails. The new funds sitting in the overall account at the bank are segmented and tracked via the virtual container accounts at the service provider, that is, the provider of the social finance platform.

When funds are ready to be transferred out, a user will send the funds via MasterCard, Visa, Automated Clearing House (ACH), or other methods to the debit card of another user, enabling instant transfer of funds both in and out of the virtual containers of the social finance platform. Because the users will be utilizing their own bank debit cards, and not one issued by the social finance service provider, the system will be a closed loop system protecting against money laundering techniques that involve cash at some point. At least some embodiments are configured such that there is no way for cash to be entered directly into the social finance system. Rather, in these embodiments, cash may have to first pass through the bank account of an individual before the cash could then be transferred to the virtual container(s) of a user via his bank debit card.

When creating a virtual container, a user of the social finance platform can input a specific description and use for the funds in that virtual container. Upon receipt of this description from the user, the service provider will have, or infer, very detailed information regarding the spending intentions of all its users. As well, the service provider will be able to provide targeted advertising options for companies desiring to reach an individual with the highest potential to purchase their product. The service provider can offer companies the capability to advertise and promote directly to consumers in the moment they desire to make and a purchase and at that moment that they have the funds to do so.

Moreover, it is in the nature of the virtual containers that they provide a ready link to everyone who has placed funds in, or pulled funds out of, that virtual container. The connections thus defined and implemented enable users of the social finance platform to share updates, upload pictures, or post notes providing a linking network to all users associated with a virtual container. Users can also select to follow their friends' virtual containers and receive updates on the activity of their friends, when such activity occurs. This social connection also empowers the creator of the virtual container to increase participation by others.

In some embodiments, the virtual containers can be used in conjunction with charitable fund raising organizations, enabling such organization to create a specific virtual container for a specific purpose and solicit funds from other users of the social finance platform. For example, if there was a natural disaster in some part of the world, the Red Cross could create a virtual container specific to that tragedy and solicit donations from users of the social finance platform.

As another example of an application for embodiments of the invention, a virtual container could be used for fantasy sports and other online gaming systems. In this particular application, funds in the virtual container can be connected to a gaming account which could help gamers in budgeting their money to not overspend. As a final illustrative example, virtual containers can also be created by users such as parents. The parents can then deposit allowances or future savings for college in those virtual containers.

With the foregoing discussion in mind, attention is directed now to a discussion of some example user accounts that can be defined in used in connection with various embodiments of the invention. These accounts are presented by way of example only and are not intended to limit the scope of the invention in any way.

In general, at least some embodiments of the invention can provide for at least three different types of user accounts. After a user signs up with the social finance platform, such as by way of an app on a user device, the user can add funds to the virtual containers in various ways, such as with a current bank debit card, or, in a second type of account, the user can obtain a prepaid debit card provided by the service provider and load that card with funds through standard methods, such as direct deposit, bank transfer, or mobile check capture, for example. These funds can then be transferred by the user from the prepaid debit card to one or more virtual containers. The bank debit card number and/or prepaid debit card number can be specified by the user when the user signs up for the social finance platform service, or at any other time prior to transfer of user funds to the virtual container(s).

In some instances, for whatever reason, a party may not sign up as a user of the social finance platform. However, the party may still wish to contribute to one or more virtual containers. In this example, the party can use a bank debit card to add funds to one or more virtual containers. For example, a family member wants to add funds to a ‘Christmas’ virtual container for another family member but does not want to sign up as a user of the social finance platform. The contributing family member can click a link in an email, for example, which takes him to a webpage where he can input his bank debit card info to contribute to the virtual container. The email can be sent to the contributing family member by a party who has an account with the service provider, such as the user or intended recipient of the virtual container.

Finally, a closed loop type of account can be implemented that is not associated with a debit card. In this type of account, the user can only move funds around in the system, for example from one virtual container to another virtual container, but the user cannot move the funds out of the system because the system is closed to those types of transactions for that type of user account. To move funds out of a closed system, the user can use a bank debit card or prepaid debit card, which are open loop. Thus, the service provider can implement two different platforms, namely, an open loop platform, and a closed loop platform. Following is a discussion of some example closed loop type accounts.

In general, a user can download the social finance platform app, which can be a mobile app in some implementations, and then use the app to sign up for the social finance platform service. Once signed up, the user can create a basic closed loop account. The user can access the funds in their virtual containers by associating a bank debit card with their account and verifying ownership of the bank account. The user can transfer funds into and out of their virtual containers with their bank debit card by way of MasterCard, Visa, Automated Clearing House (ACH), or other methods, for example. In some cases, fund limits can be set by the service provider. For example, a user may be authorized to transfer up to $500, whereas higher amounts may require that the user submit to a more detailed ‘Know Your Customer’ (KYC) process used by financial and other institutions for verifying the identity of a particular party. Some example virtual containers, discussed in more detail below, might include a ‘Birthday’ virtual container for a friend, a ‘Honeymoon’ virtual container for a wedding, or a ‘Personal Savings’ virtual container.

In the case of a ‘Birthday’ virtual container, a user ‘Ben’ could create a container for his friend, ‘Tom.’ Ben then transfers funds into that container using his bank debit card, personalizes the container with a note/picture, and grants access to Tom to transfer the funds from the ‘Birthday’ container either to one of Tom's own Jars or to Tom's debit card to spend the funds.

For the ‘Honeymoon’ virtual container, a user Ben, would create a virtual container and share it with his network of friends on the social finance platform, inviting them to contribute. His friends on the social finance platform would transfer funds from their accounts to Ben's virtual container. Ben can access the funds with his bank debit card.

In the case of a ‘Personal Saving’ virtual container, the user Ben could create a virtual container to accumulate funds for a new guitar. Ben and/or others can add money to the virtual container from time to time by transferring funds from a bank debit card into the virtual container. When Ben is ready to spend the funds, he can transfer them out of his virtual container to his bank debit card, or other account. In this way, a virtual container can be created for a single specific purpose or need, thus enabling the user to segment savings funds based on intended purposes or uses for those funds.

While the foregoing examples of a ‘Birthday’ virtual container, a ‘Honeymoon’ virtual container, and a ‘Personal Saving’ virtual container illustrate the concept of open loop social finance platform accounts, those and other virtual containers can also incorporate aspects of both closed loop and open loop accounts. Following is a description of some illustrative examples.

In the following examples, users can download the social finance platform app, which can take the form of a mobile app, and sign up with the service provider for a standard closed loop account. These users can access funds in one or more virtual containers by signing up for a second, open loop, account, which is associated, for example, with a prepaid debit card. Signing up for the open loop account with prepaid debit card requires full verification through a KYC process. The user is then able to transfer funds back and forth between their closed loop virtual containers and open loop (prepaid card) accounts. Some example virtual containers that can be defined in used in the multiple-account scenario include a ‘Birthday’ virtual container for a friend, a ‘Honeymoon’ virtual container for a wedding, or a ‘Personal Savings’ virtual container. More generally however, and as noted herein, a virtual container can be created for any reason or purpose, and the scope of the invention is not limited to the specific examples disclosed herein.

With reference first to the ‘Birthday’ virtual container example, the user, Ben, can create a virtual container for his friend, Tom. Ben then transfers funds into the virtual container from his prepaid debit card account, personalizes the virtual container with a note/picture, and grants access to Tom to transfer the funds from the ‘Birthday’ virtual container to one of his own virtual containers and/or to his debit card so that the funds are available to be spent.

In the case of the ‘Honeymoon’ virtual container, the user, Ben, can create a virtual container and share it with his network of friends on the social finance platform inviting them to contribute. This invitation can be posted by Ben to the social finance platform of the service provider and accessed and viewed by members of his network. His friends on the social finance platform would transfer funds from their accounts to the ‘Honeymoon’ virtual container. Ben can access the funds by transferring them from the ‘Honeymoon’ virtual container to his prepaid debit card.

Finally, in the ‘Personal Savings’ virtual container example, the user, Ben, would create a virtual container for saving for a new guitar. Ben and/or others can add money to that virtual container from time to time by transferring funds from his prepaid debit card into the jar. When he is ready to spend the funds, Ben can transfer the funds from his virtual container to his prepaid debit card.

Thus far, the discussion has largely concerned transfers of funds in the form of gifts or donations from a contributor to an account associated with a virtual container, and transfers from the associated account of the virtual container to a recipient of the virtual container. These transfers may be lasting, or permanent, transfers that involve no recourse. In other embodiments however, operations can be performed that involve only the temporary transfer of an asset, such as funds.

For example, virtual containers can be defined and implemented for use in connection with lending and/or borrowing an asset, such as funds. This approach is different from crowdfunding in that the parties involved with the lending and/or borrowing of an asset have formed a durable relationship with each other in which one has an asset and the other has an obligation to return the asset. In one illustrative example, a ‘Loan’ virtual container can be defined and implemented that enables a user to request an asset, such as a loan of funds. One or more lenders can contribute funds to the virtual container, to be repaid by the user of the virtual container at a later date. The loans could be micro loans from a third party loan provider.

### D. Aspects of Some Example Methods

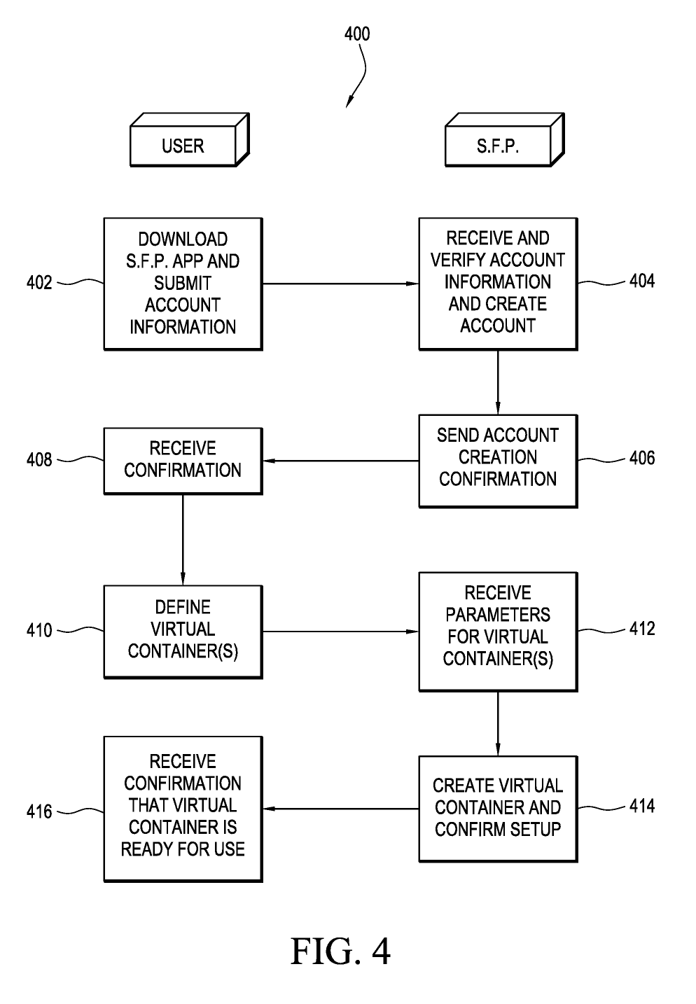

With particular reference now to FIG. 4, details are provided concerning example processes for creation of a virtual container, one of which is denoted generally at 400. As indicated in FIG. 4, the creation of the virtual container may involve activities both by a user of the social finance platform, as well as the service provider. In the example of FIG. 4, the process 400 can begin when a user sets up an account with the service provider. This process can begin when the user downloads the social finance platform app on a device such as a smartphone, and submits 402, such as by way of a graphical user interface (GUI) provided by the app, an account request and account information to the service provider. Creation of the user account may include transmission by the user of various information to the service provider, such as username, password, email address, mailing address, phone number, bank account information, routing numbers, and/or other information, passphrases, and any other information that the user desires to associate with the requested account.

The service provider receives and verifies 404 the account information from the user. Such verification can include, for example, verification of bank account information provided by the user, and may involve a request from the service provider asking a financial institution to verify the account information. If the information submitted by the user cannot be verified, the service provider can deny the account request from the user.

On the other hand, if the user account information is verified, the service provider can use the user information to create 404 a user account. Confirmation of the account creation can then be sent 406 to the user. A temporary password may be sent as part of the confirmation. At 408, the confirmation is received by the user. After the user is authorized, the user can then define 410 one or more virtual containers. This process can involve, for example, identifying various parameters, such as by way of the app GUI on the user device, that collectively define a unique virtual container. In some instances, at least, the GUI presents the user with various free-form fields in which the user can enter information. The GUI can also include fields that are associated with a displayable menu, such as a pulldown menu for example, from which the user can select a parameter or parameter value, for example. In some embodiments, some or all of the various fields presented to the user are dictated by a virtual container template that can reside at the service provider.

The user-specified parameters used to define a virtual container can include, but are not limited to: identification of authorized contributor(s) to the virtual container; identification of authorized recipient(s) for receiving/withdrawing funds from the virtual container; virtual container name; a transaction limit on the amount of funds that can be withdrawn from the virtual container within a specified time period or length of time; financial institution account(s) with which the virtual container is associated; purpose of the virtual container; goal amount of funding for the virtual container; expiration date after which funds are no longer accepted for that virtual container; name(s) and authentication information of virtual container owner(s) (may or may not include the user who creates the virtual container) who have complete access and rights to all aspects of the virtual container; and, whether/what changes or updates concerning the virtual container will be communicated to parties such as the user, and/or to those who are authorized to deposit and/or withdraw funds to/from the virtual container.

After the parameters, which can include a combination of user-specified parameters, and default parameters, have been specified, the service provider can then create the virtual container. In connection with the foregoing, default parameters can include, for example, the way in which a virtual container is displayed on a user device. For example, different container types can be displayed with different colors, fonts or other visual elements. The default parameters can reside in a database accessible by the service provider. As well, a user may be able to personalize the display of one or more virtual containers with his own graphical elements, text, or other items, which can reside locally at the user device and/or can reside at the social finance platform and be accessible there by way of the user device and social finance platform app.

Once the elements for creation of a virtual container are received 412 by the service provider, the service provider can then create 414 the virtual container. As part of the creation 414 of the virtual container, a corresponding virtual container definition can be stored in a database accessible by the service provider, and usable by the creator of the virtual container as a template for creation of additional virtual containers. This approach can save time when the user is planning to create several virtual containers that may have substantial commonality with each other in terms of their parameters. In some instances, a user can define multiple virtual containers of a set of virtual containers at substantially the same time by specifying, during a single virtual container definition session, the parameters necessary for the containers in the set.

As well, creation of the virtual container 414 can also involve performance of a verification process by the service provider. This verification process can include checking with a financial institution to verify account information provided by the user in connection with the definition of the virtual container. If the account information is verified to be correct and complete, then the virtual container will be created. On the other hand, if the service provider and/or financial institution identify any problems with the account information, such as an incorrect account or routing number for example, provided by the user, the virtual container will not be created and an error message returned from the service provider to the user that identifies the problem(s) in need of resolution. The user then has the opportunity to correct the problem(s) and resubmit the virtual container parameters.

In any case, once the virtual container has been created, the service provider can then send a confirmation 414 to the requesting user that the virtual container has been created and is available for use. After receipt 416 of the confirmation from the service provider, the user can then begin to use the virtual container.

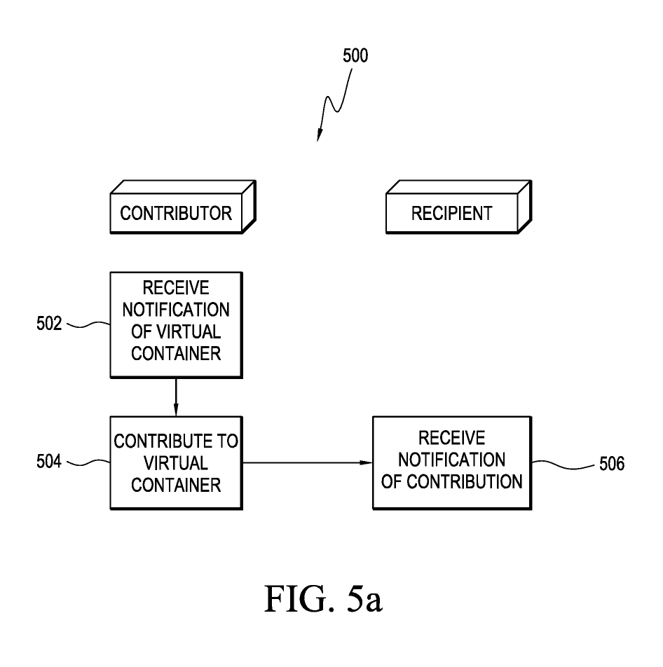

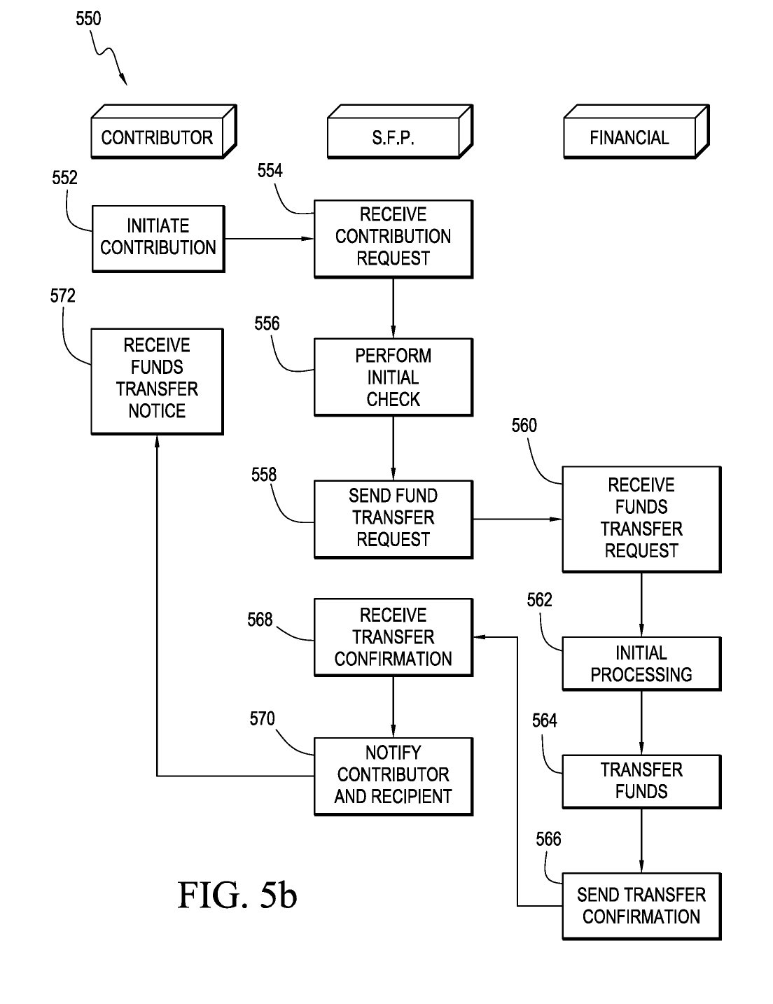

Turning now to FIGS. 5a and 5b, details are provided concerning methods for using a virtual container, one example of which is denoted generally at 500, and for handling a contribution to a virtual container, one example of which is denoted generally at 550. In general, the method 500 (FIG. 5a) can include various activities or operations performed, with respect to the virtual container, by one or more contributors/potential contributors and one or more recipients/potential recipients.

In some cases, the contributor can be notified 502, possibly automatically, when the user has created a virtual container to which the contributor is authorized to contribute. This may occur, for example, when the contributor is already associated, through the social finance platform, with the user and/or the intended recipient(s) associated with the virtual container, or can occur when the user creates the virtual container. In this latter instance, a user can specify, during the virtual container definition process, a list of authorized contributors to the new virtual container.

In other instances, a contributor can employ a search function of the social finance platform app on a smartphone or other device to search for and find 502 any virtual containers meeting criteria specified by the contributor. The search can be a keyword search, virtual container type search (for example, ‘charity,’ ‘college,’ ‘crowdfund,’ ‘joint account,’ ‘payment,’ or ‘gift’), or any other kind of search. Where a keyword search is enabled, it can allow use of multiple keywords in a single search, and/or the use of search phrases.

If the prospective contributor is not already associated with the user and/or intended recipient associated with a selected virtual container, the contributor can request authentication/authorization by the user and/or intended recipient which, if granted to the contributor, can permit the prospective contributor to contribute to the selected virtual container. This authentication/authorization can be performed by way of the service provider. For example, the prospective contributor can submit a request for authentication/authorization to the service provider which may then relay the request to the user and/or intended recipient of the selected virtual container. The user and/or intended recipient can grant or deny access to the virtual container in a return message to the service provider, which can then transmit a corresponding message to the prospective contributor.

If/when the prospective contributor is authorized to contribute, the contributor can then contribute 504 to the selected virtual container. The contribution to the virtual container can result in the generation, such as by the service provider, of a notification of the contribution. The notification of the contribution can be received 506 by the recipient associated with the virtual container. The notification can take any suitable form, such as a text, a message in the social finance app at a recipient device, or any other form, and the notification can include any appropriate content such as, for example, the name of the contributor, the amount contributed, the date/time that the contribution cleared, the name of the virtual container to which the contribution was directed, as well as a personal message from the contributor to the recipient.

In some instances, the notification is not generated or sent until there is a confirmation, such as by a financial institution and/or the service provider, that funds have actually been transferred from the contributor account to the account associated with the virtual container. Additionally, or alternatively, a message indicating an intent to contribute can be generated and sent at the initiative of the prospective contributor.

With continued reference to FIG. 5a, and directing attention now to FIG. 5b as well, details are provided concerning methods for handling a contribution to a virtual container, one example of which is denoted generally at 550. In general, the handling of a contribution to, and/or a withdrawal from, a virtual container can be performed by or at the direction of the service provider. This is possible because the social finance platform of the service provider is able to communicate directly and/or indirectly with one or more clients, financial institutions, and processors. The method 550 can be performed in connection with the process 504 of FIG. 5a. As shown in FIG. 5b, contributions to a virtual container can be performed in conjunction with various entities, such as the service provider, prospective contributor, and a financial institution which communicates with the service provider either directly or by way of a processor.

Initially, the prospective contributor can use the social finance app, or other form of the social finance functionality, to initiate 552 a contribution to a virtual container selected by the prospective contributor. Initiation 552 of the contribution can involve, for example, specifying information such as the virtual container, and the amount desired to be contributed. This information is then received 554 by the service provider as a contribution request. After receipt 554 of the contribution request, the service provider can perform an initial check 556 to determine, for example, if the virtual container still exists and is accepting contributions. As part of, or separately from, the initial check 556, the service provider can search a database to identify the financial institution and account with which the virtual container is associated, and also to identify the financial institution and account with which the prospective contributor is associated.

In any case, if the initial check 556 proves satisfactory, the service provider can then send a funds transfer request 558, directly or indirectly, to the financial institution associated with the contributor, requesting a transfer of funds from the account of the contributor to the account of the recipient. The funds transfer request can include information indicating that the transfer has been authorized by the contributor. The funds transfer request is received 560 by the financial institution which can then perform an initial processing 562 to verify the contributor account information, and confirm adequate funds to fulfill the request. In some embodiments, the initial processing 562 can be outsourced to a processor.

After the initial processing 562 is completed satisfactorily, the funds can then be transferred 564 from the contributor account to the account associated with the virtual container. In some embodiments, the funds transfer 564 can be performed by the processor instead of by the financial institution. After the funds transfer is completed, the financial institution can send a confirmation 566 of the transfer that is then received 568 by the service provider. The service provider then notifies 570 the contributor and the recipient that the funds transfer has taken place, and the notice is received 572 by the contributor and the recipient (not shown in FIG. 5b).

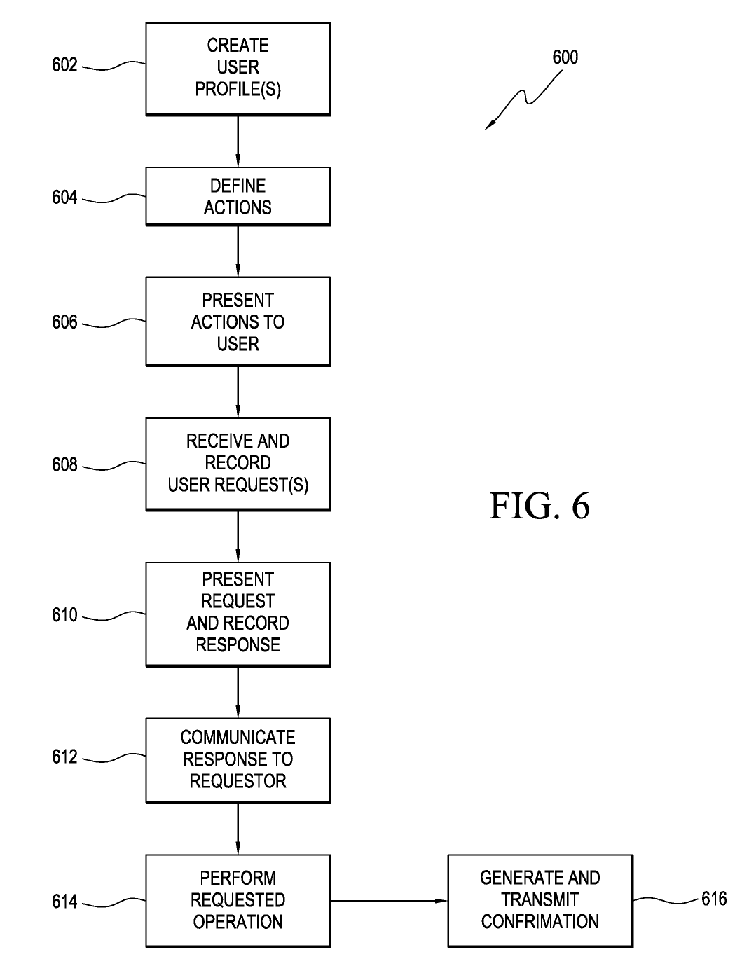

Turning now to FIG. 6, one example method that incorporates various aspects of other methods disclosed herein is disclosed and generally denoted at 600. Some or all of the method 600 can be performed by and/or at the direction of embodiments of the disclosed computer hardware, and such computer hardware can consist of, or comprise, executable instructions which, when executed by a hardware processor, carry out the method 600. As discussed below, participants in the method 600 can include one or more users of the social finance platform, the service provider, and one or more financial institutions. Finally, and as disclosed elsewhere herein, the service provider can comprise, or consist of, one or more servers hosting a social finance platform application that serves, among other things, to create, maintain, and modify the social finance platform.

Initially, the service provider can create 602 a user profile for one or more prospective users of the social finance platform. The user profile can comprise, or consist of, a user account, examples of which are disclosed herein. A user profile can be created in response to a request from the prospective user. As part of the creation of the user profile 602, the prospective user to whom that user profile corresponds can be associated by the service provider, at the request of the prospective user, with one or more other current users of the social finance platform. For example, and as noted herein, a user account can include information about other users who may be authorized to access, in one way or another, a virtual container created and administered by the owner of that user account. Also as part of the creation of the user profile 602, or subsequently, the service provider can, at the request of the prospective user, associate one or more asset accounts, such as a bank account, with the user profile. This association process can include validation, such as KYC validation for example, and linking of the asset account(s) to the user profile.

Next, the service provider can define 604 various actions that can be requested/selected by an owner and/or intended recipient of a virtual container, as well as actions that can be requested/selected by a prospective contributor to a virtual container. In at least some instances, the defined 604 actions can be presented to a user by way of a GUI displayed on the user device in conjunction with the social platform application on the user device. Such actions can include, for example, a request to contribute to a virtual container, a request to add/modify/delete a virtual container, a request to transfer funds to/from an account associated with a virtual container, a loan request and, a request to add/modify/delete a user profile. Other example actions are disclosed herein.

The various actions available to users such as an owner and/or intended recipient of a virtual container, and a prospective contributor, can then be presented 606, such as by way of a GUI, by the service platform to the user. The service platform can then receive and record 608 any user requests.

Depending upon the nature of the user request, the service platform can present 610, such as by displaying on a mobile phone or other device, a user request to another user, such as the owner or intended recipient of a virtual container. Thus, the service platform serves as a communication intermediary between a user of the social finance platform and another party, who may or may not a have an account with the social finance platform. In one example, if a user has requested to contribute or withdraw funds, the request can be presented to an owner or administrator of the associated virtual container for approval or denial. This may happen where, for example, a student requests a transfer of funds from an account associated with a virtual container administered by a parent of the student. The request would be presented to the parent for approval or denial. As part of the recording 610 of a response to a user request, the service provider can perform a verification process to ensure, in the case of a funds transfer request for example, that adequate funds exist in an associated account to satisfy the request made by the user.

In any case, the service provider can next communicate the response 612 to the requestor so as to inform the requestor as to whether or not the requested operation can or will be performed. The service provider may also, in conjunction with communication of the response 612, associate the response with the request to which the response was directed. Thus, records can be kept and maintained in a database indicating a history of requests and responses associated with a particular virtual container.

In the case where the request is approved, the service provider can then 614 perform, or direct the performance of, the requested operation. Performance of the requested operation 614 can also involve recording, in a database for example, information concerning the requested operation such as, but not limited to, the identities of the requestor and administrator, the identity of the virtual container, the nature of the requested operation and whether or not it was approved, the time and date of performance of the requested operation, if performed, the time and date of the request, and the time and date of the response to the request.

Finally, the service provider can send a confirmation 616 to the requestor and/or administrator, for example, confirming that the requested operation was performed. The confirmation 616 can also include any pertinent details concerning performance of the requested operation, examples of which are set forth above. Information included in the confirmation 616 can be displayed by recipients of the confirmation on their respective devices.

With respect to the example method 600, and the other methods disclosed herein, it should be noted that not every process included in those methods need be performed in every embodiment. Rather, other embodiments of the example methods can omit one or more of the illustrated processes.

It will be apparent that various modifications to the method 600 and/or other methods disclosed herein are possible. For example, an asset account such as a bank account for example, associated with a user and/or virtual container can be an individual account, or a joint account. The request made by a user can be a request to borrow, or lend, funds to another user.

### E. Aspects of Example GUI and Stream

With reference now to FIGS. 7a and 7b, details are provided concerning example user interfaces (UI), some particular examples of which take the form of GUIs and are denoted generally at 700, as well as an example feed, or stream, that can be generated and transmitted by the service provider. As shown in the Figures, the GUI 700 can be presented to the user by a social finance platform mobile app on a device such as the mobile phone of a user, or any other device, and can present a variety of graphical images, video, as well as text and, while not indicated in the Figures, at least some embodiments can include an audible component to the user interface. The various user interfaces disclosed herein may be referred to generally as UIs and can receive a variety of inputs from users including typed characters, drawing strokes, verbal input, and any other type of input of instruction. Likewise, the UIs can present information to a user in any form perceptible by a sense of the user including visual feedback, aural feedback, and tactile feedback such as vibrations for example.

In the particular example of FIG. 7a, the GUI 700 displays a stream that includes one or more events 702 relating to a user, or users, with whom the owner of the device that displays the GUI 700 has a relationship through the social finance platform. In at least some embodiments, the GUI 700 is only accessible by a user who has set up an account with the social finance platform. Each of the displayed events can include a name, such as ‘Yoga Startup,’ assigned to an associated virtual container by an administrator or owner of the virtual container. The user can scroll up or down to view all events 702 in his stream. The events 702 can include various other information as well such as, but not limited to, the goal amount and actual amount for the virtual container, the time and date that the event was posted, comments by the poster, graphics, and buttons to enable a user to provide input to the GUI, such as in the form of a ‘reply’ to the poster or to ‘share’ the post with others, and details related to contributors, contribution amounts, dates, and times. In some instances, events are added to a user stream as soon as they are posted while, in other embodiments, a delay can occur before the post is visible to others in the network of the poster.

As shown in FIG. 7b, a user can choose to display a list of ‘Favorites,’ that is, virtual containers that the user has a particular interest in. Each of the entries 704 in the left hand view in FIG. 7b includes basic information about a virtual container, and the user can select, such as by touching a touch screen, one of the entries to see more information about that entry, as shown in the right hand view of FIG. 7b.

Finally, the social finance platform app, in any of its various configurations and embodiments, can includes a ‘Stories’ feature. As an example, when a user creates a virtual container, the social finance platform app can present the user with the option to record video to be used as the first post associated with the virtual container. The video could be used, for example, to attract contributors to the virtual container.

Various types of notifications could be employed in connection with the videos and/or creation of a virtual container. On example of such a notification would be presented to those in the social finance platform network of the user. Some notifications can be simple, such as a post that says ‘Tom created a ‘Birthday’ jar [virtual container].’ Other notifications can be more involved.

For example, some embodiments employ filters branded in some way to demonstrate an association social finance platform and the notification and virtual container. By way of illustration, one such filter might take the form of a graphic of the virtual container of a user displayed as an insect over the lower corner of the video, while another such filter could take the form of an animated splat of ‘jelly’ in that could be displayed on the user device on cue.

As well, a video created for a purposes such as promotion of a virtual container could be shared automatically after it is created. For example, the social finance platform app can be configured to automatically distribute the video to other social media platforms, such as Facebook, Twitter, and Instagram for example, where the user has an account. Thus distributed, the video would appear in the feeds of anyone following the user on any of those social media platforms.

### F. Advantageous Aspects of Some Embodiments

In view of the disclosure herein, it will be apparent that embodiments of the invention may, for various reasons, be advantageous relative to conventional efforts that have been made in this area. For example, embodiments of the invention enable assets, such as funds for example, to be transferred to/from a user, contributor, or financial institution even if a funding goal, for example, associated with a particular virtual container has not yet been met. This approach affords significant flexibility in terms of how relationships and transfers between various parties are handled. As another example, embodiments of the invention are able to directly associate assets such as funds with a particular virtual container, and to move those assets between, for example, virtual containers. As well, embodiments of the invention can pool, or direct the pooling, of contributions to a virtual container in a bank account associated with that virtual container. As another example of advantages of some embodiments of the invention, multiple administrators/owners and/or intended recipients can be designated for a particular virtual container. For example, both parents in a family can be designated owners/administrators of a virtual container such as a ‘College Savings’ virtual container. Likewise, multiple intended recipients, such as the children of the parents in the preceding example, can be designated for a particular virtual container. Thus, the funds, for example, associated with that container can be distributed among multiple parties. Finally, embodiments of the invention enable the service provider to direct targeted advertising to users of the social finance platform.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media. As well, it should be noted that such non-transitory storage media can be included in any of the wearable devices disclosed herein. Such wearable devices can consist of, or comprise, computing devices.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

What is claimed is:

1. A method, comprising:
receiving a request to create a user profile unique to a particular user;
receiving and verifying information provided in the request;
creating the user profile;
transmitting a confirmation that the user profile has been created;
receiving, from a user to whom the user profile corresponds, a virtual container definition;
creating a virtual container based on the virtual container definition;
storing the virtual container in a virtual container database; and
confirming to the user that the virtual container has been created.

2. The method as recited in claim 1, wherein the request and virtual container definition are received by way of a user interface (UI) on a user device.

3. The method as recited in claim 2, wherein the user device is a mobile phone.

4. The method as recited in claim 1, wherein the virtual container definition includes an association of the virtual container with another party designated by the user.

5. The method as recited in claim 1, further comprising notifying the user by wireless communication when an event occurs that concerns the virtual container.

6. The method as recited in claim 1, further comprising presenting, to the user, a menu of options from which the user can select when creating a user profile.

7. The method as recited in claim 1, further comprising presenting, to the user, a menu of options from which the user can select when creating a virtual container definition.

8. The method as recited in claim 1, further comprising reassigning the virtual container such that it is associated with a user different from the user who defined the virtual container.

9. The method as recited in claim 1, further comprising granting access to the virtual container to a party who does not have a user profile.

10. The method as recited in claim 1, wherein the virtual container contains a representation of an asset.

11. A non-transitory storage medium having stored therein computer-executable instructions which, when executed by one or more hardware processors, perform and/or cause the performance of the following processes:
receiving a request to create a user profile unique to a particular user;
receiving and verifying information provided in the request;
creating the user profile;
transmitting a confirmation that the user profile has been created;
receiving, from a user to whom the user profile corresponds, a virtual container definition;
creating a virtual container based on the virtual container definition;
storing the virtual container in a virtual container database; and
confirming to the user that the virtual container has been created.

12. The non-transitory storage medium as recited in claim 11, wherein the request and virtual container definition are received by way of a user interface (UI) on a user device.

13. The non-transitory storage medium as recited in claim 12, wherein the user device is a mobile phone.

14. The non-transitory storage medium as recited in claim 11, wherein the virtual container definition includes an association of the virtual container with another party designated by the user.

15. The non-transitory storage medium as recited in claim 11, wherein the processes further comprise notifying the user by wireless communication when an event occurs that concerns the virtual container.

16. The non-transitory storage medium as recited in claim 11, wherein the processes further comprise presenting, to the user, a first menu of options from which the user can select when creating a user profile, and a second menu of options from which the user can select when creating a virtual container definition.

17. The non-transitory storage medium as recited in claim 11, wherein the processes further comprise reassigning the virtual container such that it is associated with a user different from the user who defined the virtual container.

18. The non-transitory storage medium as recited in claim 11, wherein the processes further comprise granting access to the virtual container to a party who does not have a user profile.

19. The non-transitory storage medium as recited in claim 11, wherein the virtual container contains a representation of an asset.

20. A server, comprising:
one or more hardware processors; and
the non-transitory storage medium as recited in claim 11.
